(19) United States
(12) Patent Application Publication
(10) Pub. No.: US 2018/0202639 A1
(43) Pub. Date: Jul. 19, 2018

(54) WORK LIGHT

(71) Applicant: TEST RITE INTERNATIONAL CO., LTD., Taipei (TW)

(72) Inventor: Tung Sheng Kao, Taipei (TW)

(73) Assignee: TEST RITE INTERNATIONAL CO., LTD., Taipei (TW)

(21) Appl. No.: 15/492,579

(22) Filed: Apr. 20, 2017

(30) Foreign Application Priority Data
Jan. 18, 2017 (CN) 201720064111.8

(51) Int. Cl. F21V 21/30; F21V 17/02; F21V 23/04

(52) U.S. Cl. CPC F21V 21/30; F21V 23/04; F21V 17/02

(57) ABSTRACT

A work light includes a main light holder for holding a main light and at least one auxiliary light holder for holding at least one auxiliary light; wherein the at least one auxiliary light holder is located on at least one side of the main light holder and is rotatably connected with the main light holder by at least one pivot, the at least one pivot is extended along a first direction; and the at least one pivot is located within boundaries of both sides of the at least one auxiliary light holder along a second direction, the second direction is perpendicular to the first direction. Therefore, a light-emitting angle of the auxiliary light with respect to the main light can be adjusted by rotating the auxiliary light holder, and illumination range and illumination intensity of the work light can be increased by rotating the auxiliary light holder.

### CROSS-REFERENCE TO RELATED APPLICATIONS

This application claims the benefit of priority to Chinese Patent Application No. 201720064111.8, titled “WORK LIGHT”, filed on Jan. 18, 2017, the entire disclosure of which are incorporated herein by reference.

### TECHNICAL FIELD

The present disclosure relates to illumination instruments, and more particularly, to a work light.

### BACKGROUND

Work lights are portable illumination instruments that can be applied in a variety of environments in need of light, such as a repair environment in an automobile repair shop, a built environment, and a basement environment and so on. Different environments have different requirements for the work lights. In some environments, a larger illumination range of the work lights is needed. In other environments, high illumination intensity of the work lights is required.

However, the work lights currently in the market usually have a fixed structure, when the work lights are powered on, neither the illumination intensity nor the illumination range of the work lights can be changed.

### SUMMARY

The present disclosure provides a work light of which illumination intensity and illumination range can be changed.

A work light provided according to some embodiments of the present disclosure includes: a main light holder for holding a main light and at least one auxiliary light holder for holding at least one auxiliary light; wherein the at least one auxiliary light holder is located on at least one side of the main light holder and is rotatably connected with the main light holder by at least one pivot, the at least one pivot is extended along a first direction; and the at least one pivot is located within boundaries of both sides of the at least one auxiliary light holder along a second direction, the second direction is perpendicular to the first direction.

Optionally, the first direction is a height direction of the work light.

Optionally, the at least one pivot is extended through the at least one auxiliary light holder in the first direction.

Optionally, the at least one pivot includes: at least one first sub-pivot and at least one second sub-pivot located on a same straight line, and the at least one first sub-pivot and the at least one second sub-pivot are respectively fixed at two sides of the at least one auxiliary light holder in the first direction.

Optionally, there are two auxiliary light holders located at two opposite sides of the main light holder.

Optionally, the main light holder includes at least one eave portion extending toward the at least one auxiliary light holder, and the at least one pivot is fixed on or rotatably installed on the at least one eave portion.

Optionally, the work light further includes at least one turnplate fixed at least one end of the at least one pivot, where the at least one eave portion includes at least one first groove, and the at least one turnplate is located in the at least one first groove; and the at least one turnplate is rotatably located in the at least one first groove so that the at least one pivot can be rotatably installed on the at least one eave portion.

Optionally, there are two eave portions on both sides of the at least one auxiliary light holder in the first direction, and two ends of the at least one pivot are respectively located in the two eave portions.

Optionally, there are two eave portions on both sides of the at least one auxiliary light holder in the first direction, the at least one pivot includes a first sub-pivot and a second sub-pivot located on a same straight line; and the first sub-pivot is located on one eave portion on one side of the at least one auxiliary light holder in the first direction, and the second sub-pivot is located on the other eave portion on the other side of the at least one auxiliary light holder in the first direction.

Optionally, the work light further includes a bracket for supporting the main light holder, the bracket includes a rotating shaft, and the bracket and the main light holder are rotatably connected with each other through the rotating shaft.

Optionally, the work light further includes a control switch, where the control switch has a closed state, a first open state, a second open state and a fully open state; when the control switch is in the closed state, neither of the main light and the at least one auxiliary light is illuminated; when the control switch is in the fully open state, both the main light and the at least one auxiliary light are illuminated; when the control switch is in the first open state, the main light is illuminated and the at least one auxiliary light is not illuminated; and when the control switch is in the second open state, the main light is not illuminated and the at least one auxiliary light is illuminated.

Compared with the conventional technology, the present disclosure has the following advantages.

The work light includes the main light holder and the at least one auxiliary light holder, and the at least one auxiliary light holder is located on the at least one side of the main light holder and is rotatably connected with the main light holder by the at least one pivot. Therefore, a light-emitting angle of the at least one auxiliary light with respect to the main light can be adjusted by rotating the at least one auxiliary light holder. Specifically, when the work light is in operation, an illumination range of the work light can be increased by rotating the at least one auxiliary light to make the main light and the at least one auxiliary light oriented at different angles; and illumination intensity of the work light can be increased by rotating the at least one auxiliary light holder to make an illumination range of the at least one auxiliary light and an illumination range of the main light overlapped.

### BRIEF DESCRIPTION OF THE DRAWINGS

FIG. 1 schematically illustrates a three-dimensional structural diagram of a work light according to some embodiments of the present disclosure;

FIG. 2 schematically illustrates an enlarged drawing of A area shown in FIG. 1; and

FIG. 3 to FIG. 7 schematically illustrate three-dimensional structural diagrams of the work light in different working states according to some embodiments of the present disclosure.

### DETAILED DESCRIPTION

The foregoing and other objects, features and advantages of the present disclosure will become more apparent from the following detailed description of the preferred embodiments of the present disclosure when taken in conjunction with the accompanying drawings.

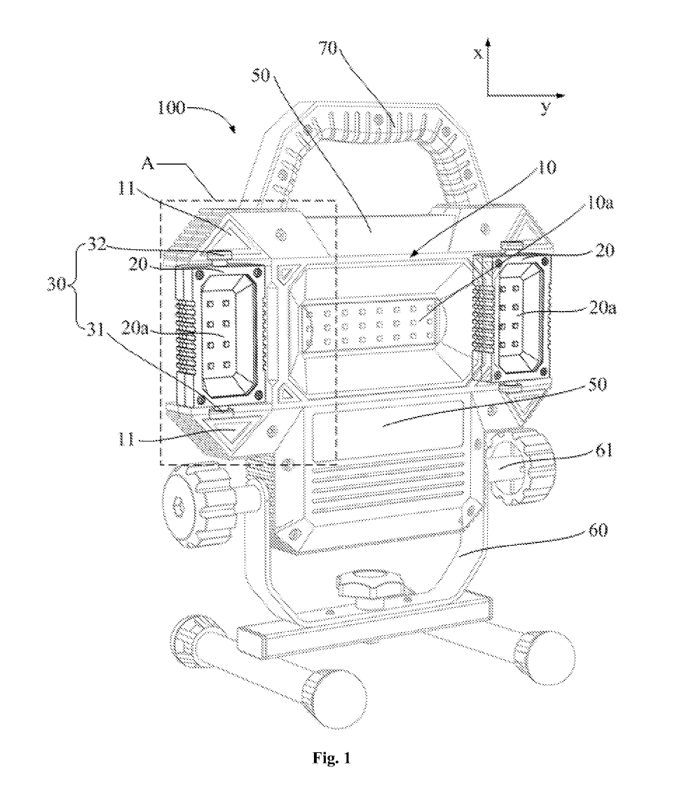

Referring to FIG. 1, FIG. 1 schematically illustrates a three-dimensional structural diagram of a work light according to some embodiments of the present disclosure. The work light 100 includes a main light holder 10 for holding a main light 10a to realize illumination. However, light emitted by the main light 10a is constant, thus neither illumination intensity nor illumination range of the work light 100 can be changed.

In some embodiments, the work light 100 further includes at least one auxiliary light holder 20 for holding at least one auxiliary light to realize illumination. Wherein the at least one auxiliary light holder 20 is located on at least one side of the main light holder 10 and is rotatably connected with the main light holder 10 by at least one pivot 30.

There is a first direction and a second direction perpendicular to the first direction in the work light 100. Specifically, the at least one pivot 30 is extended along the first direction, and the at least one pivot 30 is located within boundaries of both sides of the at least one auxiliary light holder 20 along the second direction.

Therefore, when the main light 10a and the at least one auxiliary light 20a are respectively installed in the main light holder 10 and the at least one auxiliary light holder 20, a light-emitting angle of the at least one auxiliary light 20a with respect to the main light 10a can be adjusted by rotating the at least one auxiliary light holder 20.

Then, an illumination range of the work light 100 can be increased by rotating the at least one auxiliary light holder 20. Specifically, the at least one auxiliary light holder 20 is rotated so that the at least one auxiliary light 20a and the main light 10a are oriented at different angles, thereby increasing the illumination range of the work light 100.

Illumination intensity of the work light 100 can be increased by rotating the at least one auxiliary light holder 20. Specifically, the at least one auxiliary light holder 20 is rotated so that an illumination range of the at least one auxiliary light 20a and an illumination range of the main light 10a are overlapped, thereby enhancing the illumination intensity of the work light 100.

With reference to FIG. 1, the first direction is a height direction x of the work light 100, and the second direction is a width direction y of the work light 100. That is, the at least one pivot 30 is extended along the height direction x of the work light 100, so that the at least one auxiliary light 20a can adjust its light-emitting angle in a plane perpendicular to the height direction x.

If the at least one auxiliary light holder 20 is located on a side of the work light 100 in the width direction y, then the at least one auxiliary light 20a and the main light 10a can be oriented at different angles or the illumination range of the at least one auxiliary light 20a and the illumination range of the main light 10a can be overlapped, by rotating the at least one auxiliary light holder 20.

If the at least one auxiliary light holder 20 is located on a side of the work light 100 in the height direction x, the at least one auxiliary light 20a and the main light 10a can be oriented at different angles by rotating the at least one auxiliary light holder 20.

In other embodiments, when the at least one pivot is extended along the width direction y of the work light, the at least one auxiliary light can adjust its light-emitting angle in a plane perpendicular to the width direction y.

If the at least one auxiliary light holder is located on a side of the work light in the width direction y, then the at least one auxiliary light and the main light can be oriented at different angles by rotating the at least one auxiliary light holder.

If the at least one auxiliary light holder is located on a side of the work light in the height direction x, then the at least one auxiliary light and the main light can be oriented at different angles or the illumination range of the at least one auxiliary light and the illumination range of the main light can be overlapped, by rotating the at least one auxiliary light holder.

In the present embodiment, the at least one pivot 30 is extended along the height direction x of the work light 100, the at least one auxiliary light holder 20 is located on a side of the work light 100 in the width direction y, and there are two auxiliary light holders 20 and two pivots 30 respectively located at two opposite sides of the main light holder 10.

Arrangement of one auxiliary light holder 20 on one side of the main light holder 10 can be referred to arrangement of the other auxiliary light holder 20 on the other side of the main light holder 10. Similarly, arrangement of one pivot 30 on one side of the main light holder 10 can be referred to arrangement of the other pivot 30 on the other side of the main light holder 10. Herein, only the one auxiliary light holder 20 and the one pivot 30 on the one side of the main light holder 10 will be described in detail below.

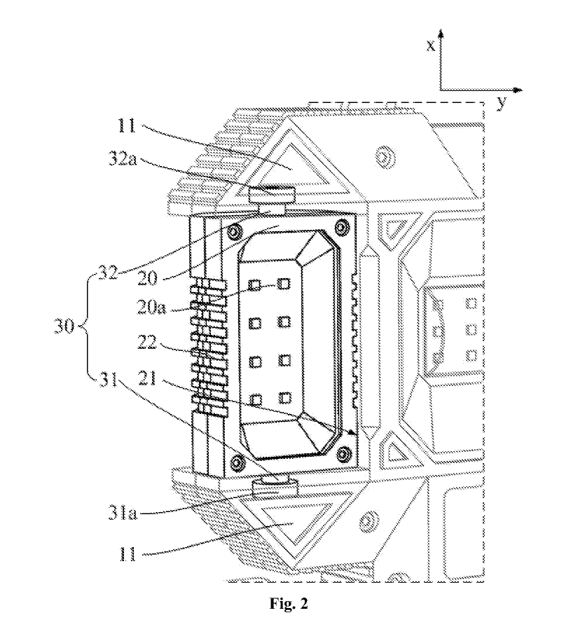

Referring to FIG. 2, FIG. 2 schematically illustrates an enlarged drawing of A area shown in FIG. 1. The one auxiliary light holder 20 has a first boundary 21 and a second boundary 22 in the width direction y, and the one pivot 30 is located between the first boundary 21 and the second boundary 22. That is, when the one auxiliary light holder 20 is rotated about the one pivot 30, both a position of the first boundary 21 and a position of the second boundary 22 are changed.

The main light holder 10 includes at least one eave portion 11 extending toward the one auxiliary light holder 20, and the one pivot 30 is located on the at least one eave portion 11. The one auxiliary light holder 20 can be rotatably connected with the main light holder 10 by the one pivot 30 in the following ways.

The one pivot 30 is rotatably located on the at least one eave portion 11 and the one auxiliary light holder 20 is fixed on the one pivot 30; or the one pivot 30 is fixed on the at least one eave portion 11 and the one auxiliary light holder 20 is rotatably located on the one pivot 30. In the present embodiment, the one pivot 30 is rotatably installed on the at least one eave portion 11, and the one auxiliary light holder 20 is fixed on the one pivot 30.

In some embodiments, there are two eave portions 11 on both sides of the one auxiliary light holder 20 in the height direction x. The one pivot 30 includes a first sub-pivot 31 and a second sub-pivot 32 located on a same straight line; and the first sub-pivot 31 is rotatably located on one eave portion 11 on one side of the one auxiliary light holder 20 in the height direction x, and the second sub-pivot is located on the other eave portion 11 on the other side of the one auxiliary light holder in the height direction x.

Specifically, there is a first turnplate 31a fixed at one end of the first sub-pivot 31, the one eave portion 11 opposite to the first sub-pivot 31 includes a first groove (not shown), the first turnplate 31a is located in the first groove, and the first turnplate 31a is rotatably located in the first groove so that the first sub-pivot 31 can be rotatably installed on the one eave portion 11.

Optionally, the first turnplate 31a can be relatively fixed with the first groove in a plurality of positions. For example, the first turnplate 31a is located in the first groove in an interference fit way, when a force is applied to the one auxiliary light holder 20, a frictional force between the first turnplate 31a and the first groove can be overcome and the one auxiliary light holder 20 can be driven to rotate about the first sub-pivot 31; when no force or a small force is applied to the one auxiliary light holder 20, the frictional force between the first turnplate 31a and the first groove can not be overcome, thus the one auxiliary light holder 20 stays in a stationary position.

In some embodiments, a convex portion is disposed on one of an outer peripheral surface of the first turnplate 31 and an inner peripheral surface of the first groove, a second groove matched with the convex portion is disposed on the other of the outer peripheral surface of the first turnplate 31 and the inner peripheral surface of the first groove, and the convex portion is located in the second groove. The rotation of the first sub-pivot 31 can be realized by applying a force to separate the convex portion from the second groove.

Similarly, a second turnplate 32a is fixed on one end of the second sub-pivot 32, the other eave portion 11 opposite to the second sub-pivot 32 includes a first groove (not shown) and the second turnplate 32a is located in the first groove; and the second turnplate 32a is rotatably located in the first groove so that the second sub-pivot 32 can be rotatably installed on the other eave portion 11.

Arrangement of the second turnplate 32a and the first groove corresponding to the second turnplate 32a may refer to the arrangement of the first turnplate 31a and the first groove corresponding to the first turnplate 31a, which will not be described in detail herein.

In some embodiments, the one pivot may be a shaft, both ends of the shaft are respectively located on the two eave portions 11 on the both sides of the one auxiliary light holder 20. That is, the one pivot is extended through the one auxiliary light holder 20 in the height direction x.

Then, a turnplate may be fixed on at least one end of the one pivot, one eave portion 11 may include a first groove, the turnplate is located in the first groove, and the turnplate is rotatably located in the first groove so that the one pivot can be rotatably installed on the one eave portion 11.

With reference to FIG. 1, the work light 100 further includes a frame 50 for fixing the main light holder 10 and a bracket 60 for supporting the main light holder 10. The at least one eave portion 11 is fixed on the frame 50.

The bracket 60 includes a rotating shaft 61 which is extended along the width direction y. The frame 60 is rotatably connected with the frame 50 by the rotating shaft 61. Since the main light holder 10 is fixed on the frame 50, a light-emitting angle of the main light 10a can be adjusted in a plane perpendicular to the width direction y by adjusting the rotating shaft 61.

Referring to FIG. 1, the work light 100 further includes a handle 70 fixed on top of the work light 100 for carrying up the work light 100.

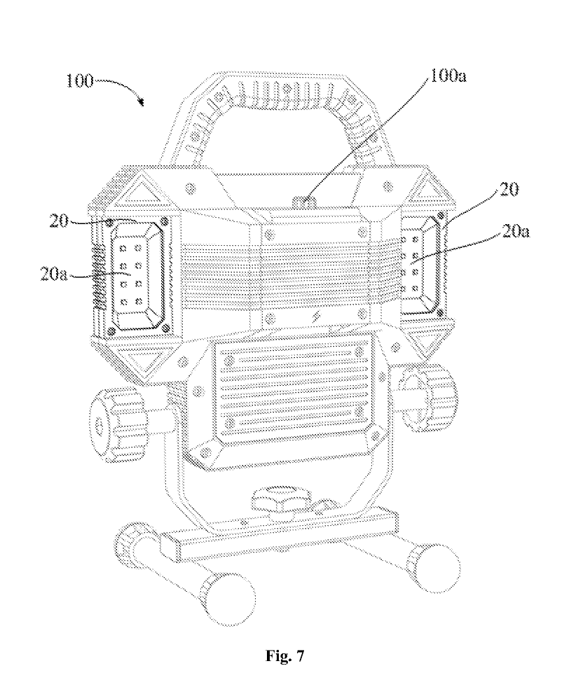

In the present embodiment, the work light 100 further includes a control switch 100a (shown in FIG. 7), and the control switch 100a has four states, namely, a closed state, a first open state, a second open state and a fully open state.

When the control switch 100a is in the closed state, neither of the main light 10a and the at least one auxiliary light 20a is illuminated; when the control switch 100a is in the first open state, the main light 10a is illuminated, and the at least one auxiliary light 20a is not illuminated; when the control switch 100a is in the second open state, the main light 10a is not illuminated and the at least one auxiliary light 20a is illuminated; when the control switch 100a is in the fully open state, both the main light 10a and the at least one auxiliary light 20a are illuminated.

Therefore, it is possible to select different states according to different situations, which can save energy and facilitate operation.

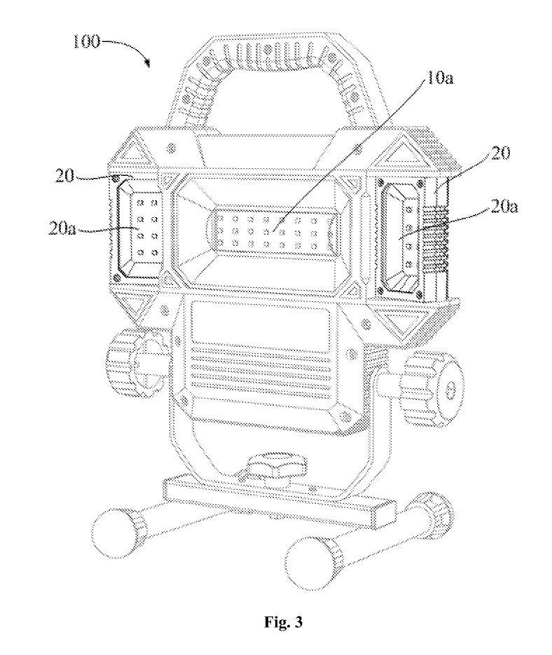

FIG. 3 to FIG. 7 schematically illustrate structural diagrams of the work light in different working states according to some embodiments of the present disclosure.

As shown in FIG. 3, the at least one auxiliary light holder 20 is rotated so that an angle between a light-emitting surface of the main light 10a and a light-emitting surface of the at least one auxiliary light 20a is larger than 0 degree and less than 180 degree. Then, an illumination range of the main light 10a is overlapped with an illumination range of the at least one auxiliary light 20a, so that illumination intensity of the work light 100 can be enhanced.

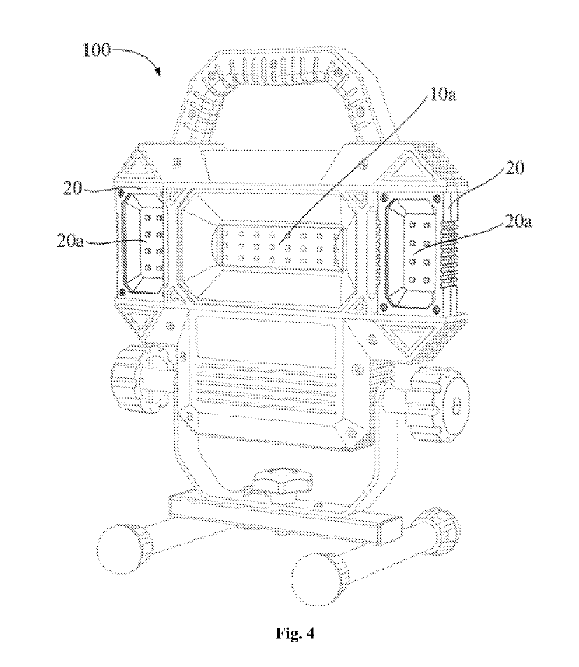

As shown in FIG. 4, the at least one auxiliary light holder 20 is rotated so that an angle between a light-emitting surface of the main light 10a and a light-emitting surface of the at least one auxiliary light 20a equals to 180 degree. Then, light emitted by the main light 10a is parallel to light emitted by the at least one auxiliary light 20a, so that an illumination range of the work light in the present embodiment can be enlarged compared with an illumination range of a work light only with the main light 10a.

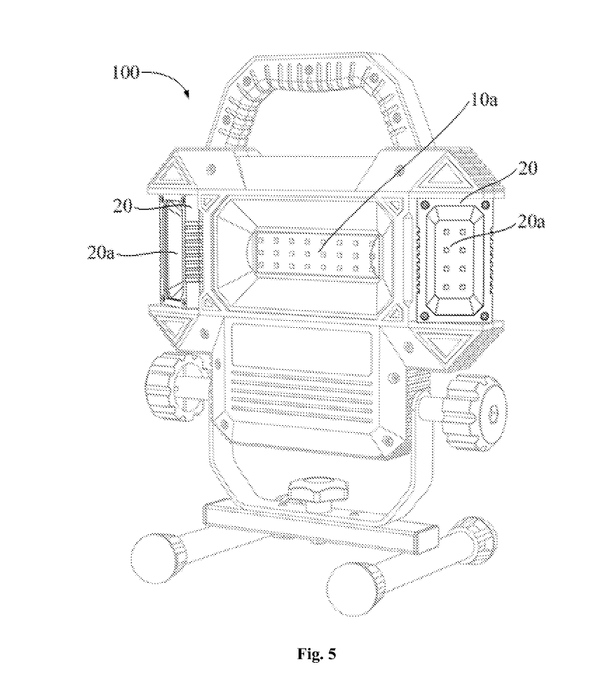

As shown in FIG. 5, the at least one auxiliary light 20 is rotated so that an angle between a light-emitting surface of the main light 10a and a light-emitting surface of the at least one auxiliary light 20a is larger than 180 degree and less than 270 degree. Then, light emitted by the main light 10a and light emitted by the at least one auxiliary light 20a are directed at different directions, so that a larger irradiation area can be obtained and the illumination range is be further enlarged.

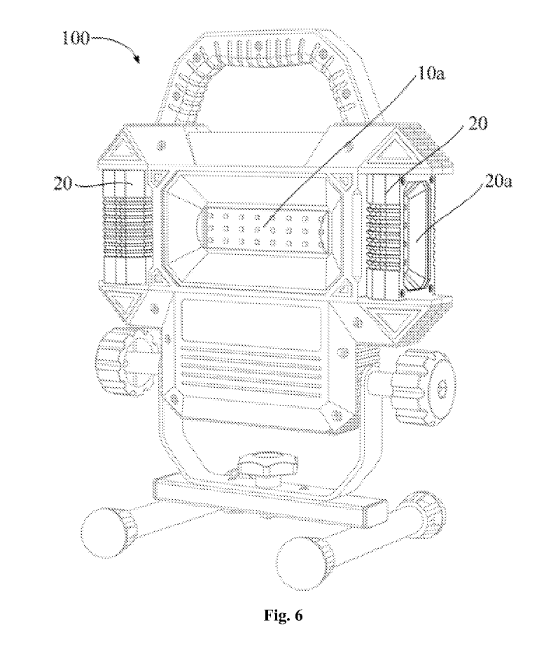

As shown in FIG. 6, the at least one auxiliary light holder 20 is rotated so that an angle between a light-emitting surface of the main light 10a and a light-emitting surface of the at least one auxiliary light 20a is larger than or equal to 270 degree and less than 360 degree. Then, light emitted by the main light 10a and light emitted by the at least one auxiliary light 20a are directed at different directions, so that the illumination range can be further increased, and a better illumination effect can be obtained in a circumferential direction of the work light 100.

As shown in FIG. 7, the at least one auxiliary light holder 20 is rotated so that an angle between a light-emitting surface of the main light (not shown) and a light-emitting surface of the at least one auxiliary light 20a is equal to 360 degree. Then, light emitted by the main light and light emitted by the at least one auxiliary light 20a are opposite to each other, so that a better illumination effect can be obtained in front-rear direction of the work light 100.

Although the present disclosure is disclosed as above, the present disclosure is not limited thereto. Any person skilled in the art will be able to make various modifications and modifications without departing from the spirit and scope of the present disclosure, and the scope of protection of the present disclosure should be determined by the scope of the claim.

1. A work light, comprising:
a main light holder for holding a main light and at least one auxiliary light holder for holding at least one auxiliary light;
wherein the at least one auxiliary light holder is located on at least one side of the main light holder and is rotatably connected with the main light holder by at least one pivot, the at least one pivot is extended along a first direction; and
the at least one pivot is located within boundaries of both sides of the at least one auxiliary light holder along a second direction, the second direction is perpendicular to the first direction.

2. The work light according to claim 1, wherein the first direction is a height direction of the work light.

3. The work light according to claim 1, wherein the at least one pivot is extended through the at least one auxiliary light holder in the first direction.

4. The work light according to claim 1, wherein the at least one pivot comprises: at least one first sub-pivot and at least one second sub-pivot located on a same straight line, and the at least one first sub-pivot and the at least one second sub-pivot are respectively fixed at two sides of the at least one auxiliary light holder in the first direction.

5. The work light according to claim 1, wherein there are two auxiliary light holders located at two opposite sides of the main light holder.

6. The work light according to claim 1, wherein the main light holder comprises at least one eave portion extending toward the at least one auxiliary light holder, and the at least one pivot is fixed on or rotatably installed on the at least one eave portion.

7. The work light according to claim 6, further comprising at least one turnplate fixed at least one end of the at least one pivot, wherein the at least one eave portion comprises at least one first groove, and the at least one turnplate is located in the at least one first groove; and
the at least one turnplate is rotatably located in the at least one first groove so that the at least one pivot can be rotatably installed on the at least one eave portion.

8. The work light according to claim 6, wherein there are two eave portions on both sides of the at least one auxiliary light holder in the first direction, and two ends of the at least one pivot are respectively located in the two eave portions.

9. The work light according to claim 6, wherein there are two eave portions on both sides of the at least one auxiliary light holder in the first direction, the at least one pivot comprises a first sub-pivot and a second sub-pivot located on a same straight line; and
the first sub-pivot is located on one eave portion on one side of the at least one auxiliary light holder in the first direction, and the second sub-pivot is located on the other eave portion on the other side of the at least one auxiliary light holder in the first direction.

10. The work light according to claim 1, further comprising a bracket for supporting the main light holder, the bracket comprises a rotating shaft, and the bracket and the main light holder are rotatably connected with each other through the rotating shaft.

11. The work light according to claim 1, further comprising a control switch, wherein the control switch has a closed state, a first open state, a second open state and a fully open state;
when the control switch is in the closed state, neither of the main light and the at least one auxiliary light is illuminated;
when the control switch is in the fully open state, both the main light and the at least one auxiliary light are illuminated;
when the control switch is in the first open state, the main light is illuminated and the at least one auxiliary light is not illuminated; and
when the control switch is in the second open state, the main light is not illuminated and the at least one auxiliary light is illuminated.
